(19) United States
(12) Patent Application Publication
(10) Pub. No.: US 2004/0073809 A1
(43) Pub. Date: Apr. 15, 2004

(54) System and method for securing a user verification on a network using cursor control

(76) Inventor: Bernard Ignatius Ng Wing Keong, Singapore (SG)

Correspondence Address: HOGAN & HARTSON LLP, ONE TABOR CENTER, SUITE 1500, 1200 SEVENTEEN ST., DENVER, CO, 80202, US

(21) Appl. No.: 10/268,328

(22) Filed: Oct. 10, 2002

(51) Int. Cl. H04L 9/32

(52) U.S. Cl. 713/201; 713/150

(57) ABSTRACT

A system and method for securing a user on a network using a cursor control is disclosed. The system includes a client and a server. The server includes a back-end component that generates graphics that include a keyboard. The key on the keyboard may be randomly assigned. The graphic is displayed on the client. The user enters a sequence of character coordinates by clicking on the keyboard within the graphic. The sequence is captured and forwarded to the back-end component for authentication.

### BACKGROUND OF THE INVENTION

1. Field of the Invention

The present invention relates to computer networks and, more particularly, the invention relates to the security of computer networks wherein a client is used to access servers within the network. The present invention also relates to obtaining security information or registering a user or client on the network in a secure manner using a cursor control.

2. Discussion of the Related Art

Security compromises are of increasing concern with regard to computer networks and security. Hackers, perpetrators, and unauthorized access may occur when the security of a workstation, personal computer, laptop, or any other computing platform is compromised. Access may be granted to files on the computing device or on the network to anyone using that device.

One way to compromise security is by capturing all the past keystroke events on the computer. These actions may be supplemented by searching for sequences of URLs, IDs, and passwords. This form of attack may succeed even if websites, accounts, or files are secured using HTTPS, applets that encrypt the authentication sequence, or other security mechanisms. Security may be developed using hardware tokens, but implementation of additional hardware increases costs and processing time. Another potential security operation is to authenticate a user using a series of images, or graphics. For example, a user may authenticate using human faces to prompt the user to click on the appropriate face. These actions, however, may be time consuming and difficult to implement as they change the convention of using textual passwords.

### SUMMARY OF THE INVENTION

Accordingly, the present invention is directed to a system and method for securing a user on a network using a cursor control.

Additional features and advantages of the disclosed embodiments will be set forth in the description which follows, and in part will be apparent from the description, or may be learned by practice of the invention. The objectives and other advantages of the disclosed embodiments may be realized and attained by the structure particularly pointed out in the written description and claims hereof as well as the appended drawings.

To achieve these and other advantages, a system for securing a user on a network via a login process is disclosed. The system includes a server having a back-end component to generate a graphic. The graphic includes a keyboard. The system also includes a client to receive the graphic and to display the graphic to the user. The system also includes a cursor control coupled to the client to indicate cursor coordinates on the keyboard using a cursor. A sequence of the cursor coordinates is sent to the back-end component to authenticate the sequence.

According to the disclosed embodiments, a secure login system for a network is disclosed. A user enters an identification and a password at a client. The secure login system includes a graphic generated by a server coupled to the client via the network. The graphic is supported by an applet at the client. The secure login system also includes a keyboard represented within the graphic. The keyboard has keys indicating different characters. The secure login system also includes a back-end component at the server to generate the keys on the keyboard. The secure login system also includes a sequence of coordinates captured by the applet that correlate to the keys. The sequence is indicated by clicking a cursor over the keys. The secure login system also includes a data packet comprising the sequence of coordinates. The data packet is sent to the back-end component.

According to the disclosed embodiments, a method for securing a user on a network via a login process is disclosed. The method includes requesting a graphic including a keyboard, by a client. The graphic is generated at a server coupled to the client via the network. The method also includes capturing a sequence of characters using a cursor control coupled to the client. The method also includes forwarding the sequence of characters to the server. The method also includes authenticating the user using the sequence of characters.

It is to be understood that both the foregoing general description and the following detailed description are exemplary and explanatory and are intended to provide further explanation of the disclosed embodiments as claimed.

### BRIEF DESCRIPTION OF THE DRAWINGS

The accompanying drawings, which are included to provide further understanding of the invention and are incorporated in and constitute a part of this specification, illustrate the disclosed embodiments and together with the description serve to explain the principles of the disclosed embodiments. In the drawings:

FIG. 1 illustrates a system for securing a user on a network in accordance with the disclosed embodiments.

FIG. 2A illustrates a keyboard that is displayed in a graphic at a client in accordance with the disclosed embodiments.

FIG. 2B illustrates a keyboard that is displayed in a graphic at a client in accordance with the disclosed embodiments.

FIG. 3 illustrates a graphic displaying a floating keyboard to receive commands from a cursor control in accordance to the disclosed embodiments.

FIG. 4 illustrates a flowchart for securing a user on a network in accordance with the disclosed embodiments.

### DETAILED DESCRIPTION OF THE PREFERRED EMBODIMENTS

Reference will now be made in detail to the preferred embodiment of the present invention, examples of which are illustrated in the accompanying drawings.

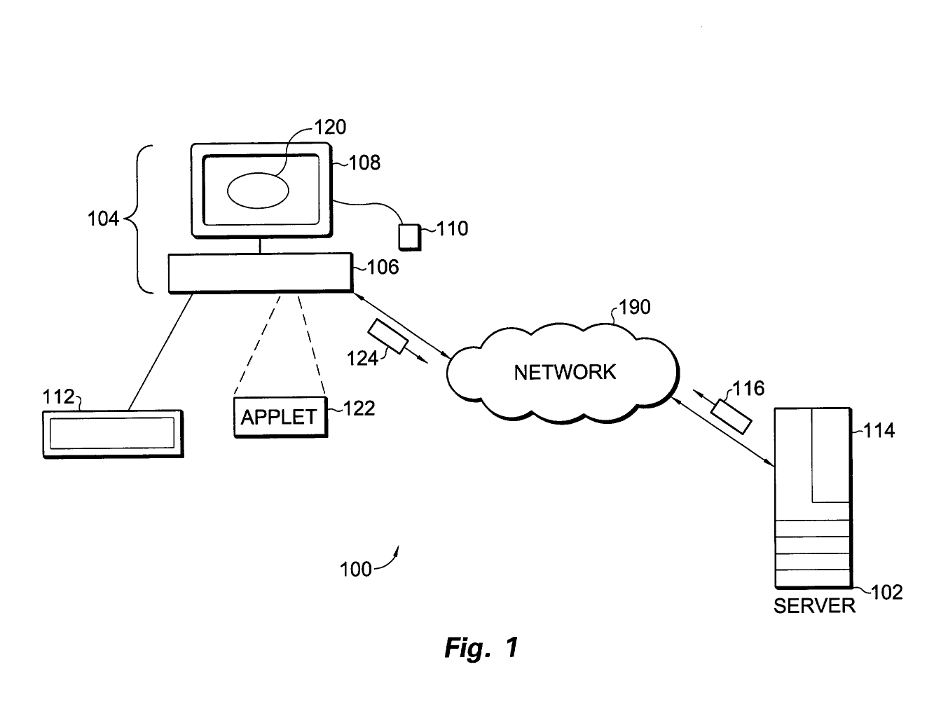

FIG. 1 depicts a system 100 for securing a user on a network in accordance with the disclosed embodiments. System 100 may include any network that allows data and information to be exchanged between computing platforms, such as laptops, desktops, and the like. System 100 may use the Internet, local area networks, wide area networks, and the like. As depicted, system 100 exchanges information between server 102 and client 104. Both server 102 and client 104 are computing platforms that include a processor and memory coupled to the processor to store instructions to be executed on the processor. Preferably, server 102 may be known as a back-end server.

Server 102 and client 104 are coupled via network 190. Preferably, network 190 is the Internet, as disclosed above. Network 190 provides the infrastructure to facilitate data exchange. Network 190 may be configured according to any known manner. Alternatively, network 190 may be a local area network, a wide area network, a virtual network, and the like. Network 190 may utilize fiber optics, telephone lines, coaxial cables, or any other form of transmission medium known to those skilled in the art.

Client 104 includes computer 106, display 108, and cursor control 110. Computer 106 is coupled to display 108. Display 108 may be a monitor, flat screen, and the like. Cursor control 110 may be any device that controls the position of the cursor on display 108, and is coupled to computer 106. Preferably, cursor control 110 is a mouse or trackball. Computer 106 also is coupled to keyboard 112. Keyboard 112 allows keystrokes to be received by computer 106. Cursor control 110, as shown, may be coupled to computer 106 separately from keyboard 112. Alternatively, cursor control 110 may be embedded or coupled to keyboard 112.

Server 102 includes back-end component 114. Back-end component 114 may be a computer program or module that executes on server 102. The functionality of back-end component 114 is disclosed in greater detail below. Back-end component 114 generates data for graphic 120 to receive password, identifications, or other information from client 104. This data may be sent in data packet 116 over network 190.

Client 104 receives data packet 116. Using data packet 116, graphic 120 may be generated. As a result, graphic 120 may be displayed on display 108 using an applet 122. Computer 106 receives data packet 116 and, using applet 122, converts the data into graphic 120. Graphic 120 preferably includes a graphic of a keyboard. The graphical keyboard may be known as a floating keyboard. Using cursor control 110, a user clicks various coordinates on graphic 120. This information is placed in data packet 124 that is sent to server 102. Back-end component 114 compares the information within data packet 124 to the information generated earlier to authenticate the user. Thus, use of keyboard 112 to enter information for security and identification can be completely avoided. Preferably, cursor control 110 is used to enter at least one character of a password.

Preferably, back-end component 114 generates a keyboard to be displayed on display 108. The keyboard may be in any configuration. Preferably, the keys are randomly situated. In other words, the keys may not be in the same place within graphic 120 each time it is displayed. Only back-end component 114 is aware of the location of the keys, and this information preferably is not forwarded to client 104. The keys may be placed within graphic 120 according to x,y coordinates. Once the user clicks on certain locations within graphic 120, the x,y location of the click is stored to be sent in data packet 124. Server 102 receives coordinates for the location of the sequence of clicks, but not any information pertaining to the letters displayed within graphic 120. Back-end component may compare the received “clicked” locations with the locations expected from graphic 120 to verify or reject the log-in attempt.

The disclosed embodiments may further modify the information prior to sending data packets to client 104 from server 102, and vice versa. Back-end component 114 may randomize the layout of graphic 120 for each log-in attempt. This action may frustrate hackers or other outside entities from intercepting the data and reverse mapping on a keyboard to identify the identification or the password. A large number of different keyboard configurations may exist. Further, data packet 116 may be encrypted prior to transmission to client 104. Client 104 may include an encryption key such that the information in data packet 116 is decrypted prior to displaying graphic 120. Moreover, information from client 104 to server 102 may be encrypted for additional security. Server 102 may include different encryption keys for each client 104 within system 100.

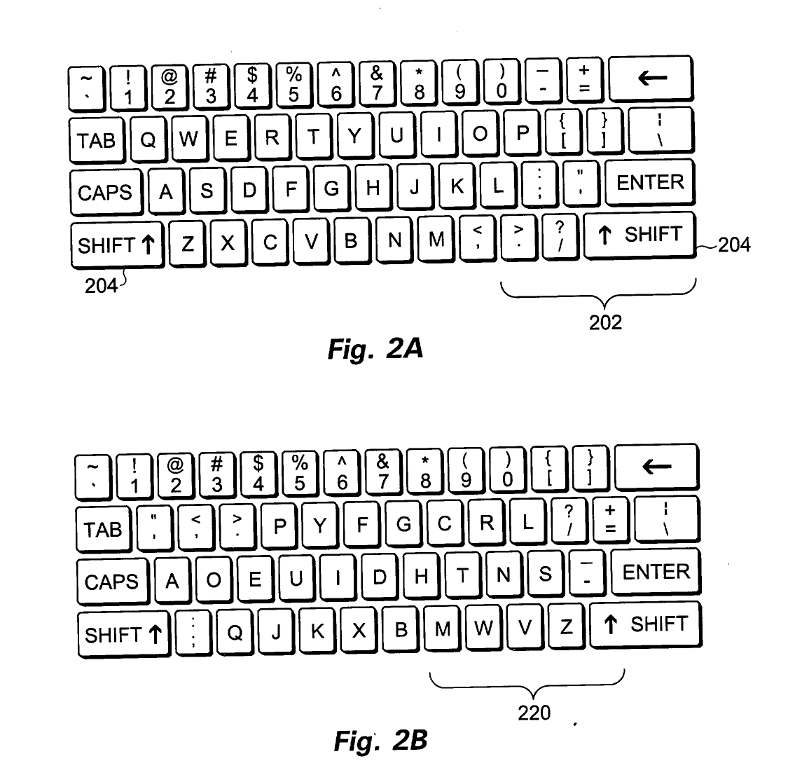

As disclosed above, cursor control 110 may click, or otherwise indicate, on graphic 120. Characters on the floating keyboard are identified by the clicks. Coordinates with reference points within graphic 120 are indicated on each click. Preferably, graphic 120 is representative of a keyboard where all the letters and other symbols are placed in specific locations on the virtual keyboard, such as keys. FIG. 2A depicts a keyboard 202 that is displayed in a graphic at a client in accordance with the disclosed embodiments. Keyboard 202 resembles a “QWERTY” keyboard in its key placement. Shift keys 204 may act like shift keys on a keyboard to toggle the other keys in keyboard 202. FIG. 2B depicts a keyboard 220 that is displayed in a graphic at a client in accordance with the disclosed embodiments. Keyboard 220 differs from keyboard 202 in the placement of the letter keys. Keyboard 220 resembles a “DVORAK” keyboard in its key placement, but any random placement will be sufficient. The keys may be randomly assigned according to an algorithm in the back-end component, such as back-end component 114. Alternatively, keyboards 202 and 220 may be stored as files on server 102. Back-end component 114 may select a file at random to send to client 104, wherein the keys already have been assigned. Keyboards 202 and 220 disclose how randomizing the layout may prevent hackers from inferring information even if they are recording the position of each click of the cursor control, or pointer device. For example, the letter “q” may be part of the password or identification string. Q is in a different position on keyboard 220 when compared to keyboard 202 with relation to the top left corner. Thus, a “click” on Q in a graphic displaying keyboard 220 would be in a different location than a click on Q in keyboard 202.

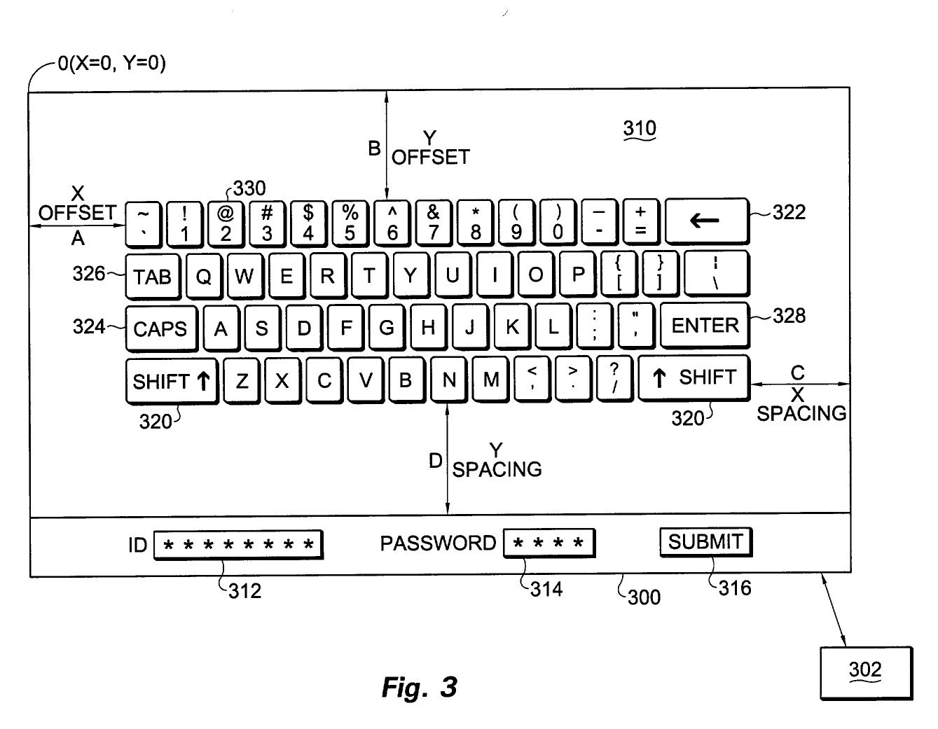

FIG. 3 depicts a graphic 300 displaying a floating keyboard 310 to receive commands from a cursor control 302 in accordance to the disclosed embodiments. Graphic 300 may be displayed at a client on a network, such as client 104 in FIG. 1. Cursor control 302 may move a cursor also displayed at the client within graphic 300. A user uses cursor control 302 to indicate a selection within graphic 300. The results of the selection may be noted in identification input box 312 or password input box 314. The selections via cursor control 302 may correlate to the displayed keys in floating keyboard 310. Floating keyboard 310 is displayed within graphic 300.

Selections from cursor control 302 may be intermixed with selections or commands from a keyboard, such as keyboard 112 in FIG. 1. Thus, keystrokes from a keyboard also may be displayed within input field 312 or 314. A mixed mode entry may be utilized with cursor control 302 and a keyboard. Thus, logging in using graphic 300 may be deployed using two modes, pure cursor control entry and mixed cursor control and keyboard entry. Using pure cursor control entry, the user uses cursor control 302 to click on the rendered keyboard image in floating keyboard 310 to enter the characters in identification input box 312 or password input box 314. In the mixed cursor control and keyboard entry, the user may mix typing in characters with clicking on the floating keyboard 310.

The mixed cursor control and keyboard entry may be preferable if the user is not initially comfortable with the randomized keyboard layouts. As long as one or more characters of the user's identification or password are clicked in, and not typed, a potential intruder may not be able to compromise the user's account. A hacker would have to determine which character positions were typed and which ones were clicked in, and then try every combination of allowed characters for the positions that were clicked in. Even then, a hacker may not be able to compromise security as pointer clicks may not necessarily correspond to log in identification or passwords. For example, a user may click on a blank space in floating keyboard 310, or click on a modifier key, such as shift keys 320.

Floating keyboard 310 is depicted in a QWERY configuration, but the keys may be randomly assigned, as disclosed above. Floating keyboard 310 may include additional random aspects. X-axis offset A and x-axis spacing C may be random in positioning the keys of floating keyboard 310 in the horizontal plane. Y-axis offset B and y-axis spacing D may be random in positioning the keys of floating keyboard 310 in the vertical plane. The randomness in the offsets and spacings may protect against hackers that capture the position of each window and try to map the clicked coordinates if the keys are in a default offset from origin O.

When selecting a key, the user may click the cursor “on target.” The identification input field 312 and password input field 314 may provide feedback on whether a character entry succeeded by showing an “*” in the appropriate field. For example, if a login identification is “bnixon,” then “******” is displayed in identification input field 312. Thus, a sequence of characters is selected by user. If the user happens to click in between the keys, then the event handling of graphic 300 may detect the error and not display anything in input fields 312 or 314. The coordinates of the erroroneous click may still be communicated. Alternatively, animation may flash the hit key or sounds may be generated to represent hit keys or misses to reduce user errors.

Certain keys displayed in floating keyboard 310 may be modal in function. These keys affect the identification and password indirectly. For example, backspace key may erase the last character entry in a field. Caps lock key 324 may be highlighted or continually flashed when it is activated, and returns to the same look as the other keys when it is deactivated. Shift keys 320 may be highlighted or animated, but may revert back to normal state after any other key is clicked. If the user activates cap lock key 324 and shift keys 320 before clicking or typing another key, the result may be as if neither key was activated. Tab key 326 may exhibit the same behavior as on a webpage, such that it moves the focus from one input field to the next. In the disclosed embodiments, tab key 326 may toggle character entry from identification input field 312 to password input field 314. Enter key 328 may shift focus from identification input field 312 to password input field 314 if the user is in the midst of entering their identification, but may submit the identification and password combination if the user is in the midst of entering their password. The user also may submit the identification and password combination by clicking submit key 316.

An overlay may pop up and partially obscure floating keyboard 310, or graphic 300, when the user has entered their identification and password via enter key 328, submit key 316, or the physical [Enter] key on keyboard 112. The overlay provides feedback to the user that the submission is occurring. The overlay may display text messages, such as “user being authenticated, please wait.” The overlay may be removed when the back-end component or server responds positively or negatively. If denied, a retry may be prompted.

According to the disclosed embodiments depicted in FIG. 3, no spacebar, control, or alt keys are shown. Preferably, a bottom row does not exist on floating keyboard 310 that resembles the bottom row of conventional keyboards. This removal of the bottom row may save space within graphic 300. Spaces, controls and alt-meta characters may be disallowed as identifications and passwords. Alternatively, these keys may be present within floating keyboard 310.

According to the disclosed embodiments, every key within floating keyboard 310 may be represented by rectangles of various sizes. The top left corner of a key, such as key 330, may be known as “TL” and has coordinates TL-x and TL-y. The bottom right corner of key 330 may be known as “BR” and has coordinates BR-x and BR-y. When the cursor control is clicked with the boundaries of key 330, the clicked coordinates, known as CLK-x and CLK-y, may be subject to this formula:

TL-x [symbol] CLK-x [symbol] Br-x

TL-y [symbol] CLK-y [symbol] BR-y

Thus, any system hosting graphic 300 may detect if cursor control 302 has been clicked on any key within floating keyboard 310. One process may be iterating through every key within floating keyboard 310 to determine if CLK-x and CLK-y are within the boundaries of the key. Another process may divide the entire clickable area of graphic 300 into a matrix of fixed-size rectangular regions. Preferably, the regions have an average width and height of the keys. A technique known as hashing may add all the potential keys that may be clicked into separate lists for each region. If there are hundreds or thousands of clickable keys, this process may be an order of magnitude faster because the process checks a short list of keys in the region versus every key on floating keyboard 310. A hashtable may be used despite the fact that keys may end up in four regions. Bigger keys, such as shift keys 320, may be in eight regions. The tradeoff may be sacrificing memory space to gain processing time.

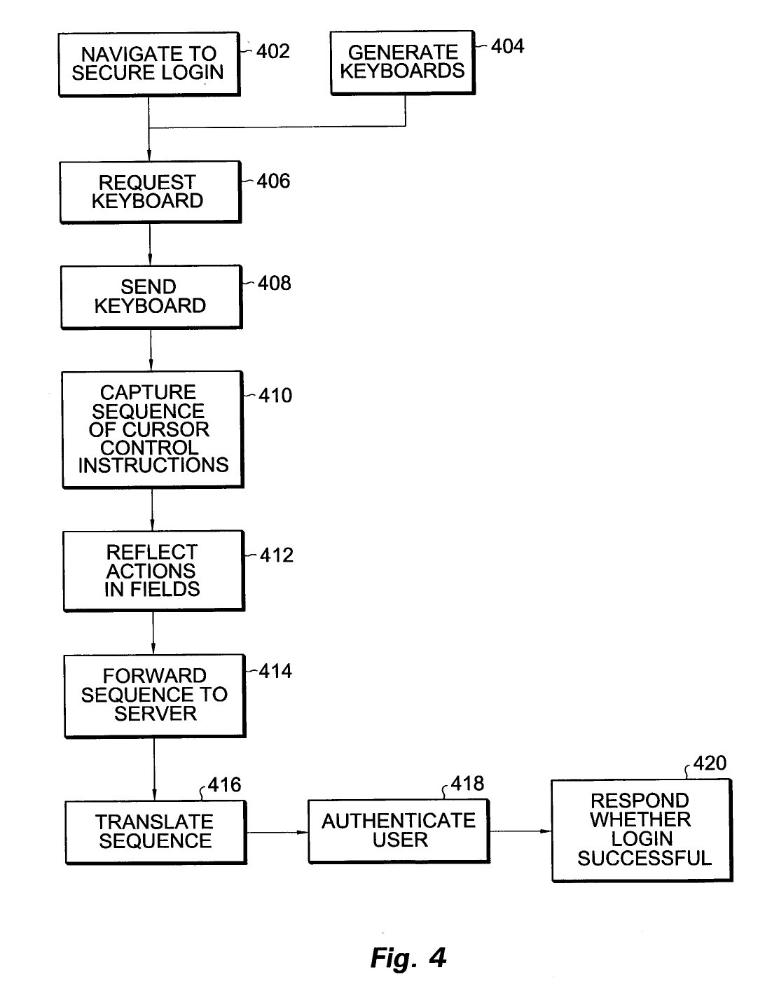

FIG. 4 depicts a flowchart for securing a user on a network in accordance with the disclosed embodiments. Step 402 executes by navigating a user to a secure login. The secure login may be a secure website or webpage. Alternatively, the secure login may be a startup page for logging onto a network. Preferably, the secure login is located at a client coupled to a network. Step 404 executes by generating keyboards at a server coupled to a network that supports the secure login at the client. The keyboards may be generated randomly by the server. The keyboards may be generated prior to the execution of step 402, and step 402 and 404 do not need to be executed simultaneously.

Step 406 executes by requesting a generated keyboard from the server. Step 408 executes by sending the keyboard over the network. Specifically, the keyboard is sent as a data packet that enables a graphical representation of the keyboard to be displayed, or a floating keyboard. The floating keyboard is displayed at the client.

Step 410 executes by capturing the sequence of cursor control instructions, or clicks, performed within the displayed graphic of the keyboard. A sequence of characters is inputted. Further, keystrokes from a real keyboard may be captured. The clicks and strokes may reflect an identification and password combination to securely login the network. Step 412 executes by reflecting the actions of the cursor control or the keyboard inside fields within the displayed graphic. Thus, the user may determine whether an instruction has been captured by the client.

Step 414 executes by forwarding the captured sequence of coordinates to the server. The information for the sequence may be encrypted for increased security. If encrypted, the server decrypts the information. Step 416 executes by translating the sequence onto the generated keyboard. Using the coordinates captured in the sequence, the server may determine the key being indicated by the user. Step 418 executes by authenticating the user by comparing the translated key sequences with the expected identification and password combination. If the sequences match the expected combination, then the user is authenticated. Step 420 executes by responding to the user whether the login was successful. If the login failed, the user may be prompted to enter the information again. After several failures, such as four, network security or other personnel may be alerted. Further, the user may be prevented from attempting additional logins.

According to the above-disclosed embodiments, any computer may be used in implementing the present invention. Java-based systems, however, may be preferable to other systems. Java supports a feature called object serialization that makes it really trivial to transmit objects over networks. The randomly generated keyboard and the accompanying hashtable-based event-handling code can be sent in one line of Java. Other programming environments may require tedious tasks on both client and server ends known as object marshaling and unmarshaling.

It will be apparent to those skilled in the art that various modifications and variations can be made without departing from the spirit or scope of the disclosed embodiments. Thus, it is intended that the disclosed embodiments cover the modifications and variations of the present invention provided that they come within the scope of any claims and their equivalents.

What is claimed:

1. A system for securing a user on a network via a login process, comprising:
a server having a back-end component to generate a graphic, wherein said graphic includes a keyboard;
a client to receive said graphic and to display said graphic to said user; and
a cursor control coupled to said client to indicate character coordinates on said keyboard using a cursor, wherein a sequence of said character coordinates is sent to said backend component to authenticate said sequence.

2. The system of claim 1, further comprising an applet to receive said graphic and to receive said sequence of character coordinates indicated by said cursor.

3. The system of claim 1, wherein said graphic is generated randomly by said back-end component.

4. The system of claim 1, wherein said sequence of character coordinates is encrypted.

5. The system of claim 1, wherein said sequence of character coordinates is indicated within said graphic.

6. The system of claim 1, further comprising a keyboard coupled to said client to indicate said sequence of characters.

7. The system of claim 1, where said characters on keys within said keyboard.

8. The system of claim 1, wherein said sequence of characters indicates coordinates within said keyboard indicated by said cursor control.

9. A secure login system for a network, wherein a user enters an identification and a password at a client, comprising:
a graphic generated by a server coupled to said client via said network, wherein said graphic is supported by an applet at said client;
a keyboard represented within said graphic, said keyboard having keys indicating different characters;
a back-end component at said server to generate said keys on said keyboard;
a sequence of character coordinates correlating to said keys, captured by said applet, wherein said sequence is indicated by clicking a cursor over said keys; and
a data packet comprising said sequence of character coordinates, wherein said data packet is sent to said back-end component.

10. The secure login system of claim 9, wherein said data packet is encrypted.

11. The secure login system of claim 9, further comprising a cursor control to control said cursor.

12. The secure login system of claim 9, wherein said keyboard is generated randomly.

13. The secure login system of claim 9, wherein said back-end component translates and compares said sequence to said keyboard.

14. A method for securing a user on a network via a login process, comprising:
requesting a graphic including a keyboard from a client, wherein said graphic is generated at a server coupled to said client via said network;
capturing a sequence of character coordinates using a cursor control coupled to said client;
forwarding said sequence of character coordinates to said server; and
authenticating said user using said sequence of character coordinates.

15. The method of claim 14, wherein said graphic is randomly generated.

16. The method of claim 14, further comprising encrypting said sequence of character coordinates.

17. The method of claim 14, further comprising translating said sequence of character coordinates at said server.

18. The method of claim 14, wherein said authenticating includes comparing said sequence of character coordinates to said keyboard to determine an identification and a password.
